(19) United States
(12) Patent Application Publication
(10) Pub. No.: US 2026/0118099 A1
(43) Pub. Date: Apr. 30, 2026

(54) ENTERTAINMENT SYSTEM AND A METHOD FOR IMPLEMENTING SAME

(71) Applicants: Christopher F. Hoth, Gales Ferry, CT (US); Mark D. Blanchard, Fleming Island, FL (US); Alexander J. Hoth, Gales Ferry, CT (US); Breanna Hoth, Gales Ferry, CT (US); Matthew P. Blanchard, Fleming Island, FL (US)

(72) Inventors: Christopher F. Hoth, Gales Ferry, CT (US); Mark D. Blanchard, Fleming Island, FL (US); Alexander J. Hoth, Gales Ferry, CT (US); Breanna Hoth, Gales Ferry, CT (US); Matthew P. Blanchard, Fleming Island, FL (US)

(21) Appl. No.: 19/371,786

(22) Filed: Oct. 28, 2025

Related U.S. Application Data
(60) Provisional application No. 63/712,870, filed on Oct. 28, 2024.

(51) Int. Cl. F41J 9/02; F41J 5/14; G05D 1/248; G05D 105/60

(52) U.S. Cl. CPC F41J 9/02; F41J 5/14; G05D 1/248; G05D 2105/60

(57) ABSTRACT

An entertainment system including at least one support pole, at least one attachment cord, a motor, wherein the motor is associated with the support pole and the attachment cord and a target, wherein the target is connected to the attachment cord, and wherein the motor is operable to cause the target to move in at least one of a vertical direction, a horizontal direction and a circular direction relative to the at least one support pole via the attachment cord.

### CROSS-REFERENCE TO RELATED APPLICATIONS

This application is related to and claims the benefit of priority of the filing date of U.S. Provisional Patent Application Ser. No. 63/712,870 (Attorney Docket No. 32456-4), filed on Oct. 28, 2024, and titled “Entertainment System and a Method for Implementing Same,” the contents of which are incorporated herein by reference in its entirety.

### FIELD OF THE INVENTION

The present invention relates generally to a gaming apparatus, and more particularly to a gaming apparatus for targeting and acquiring a moving target and a method for implementing the gaming apparatus.

### BACKGROUND OF THE INVENTION

Current gaming and target acquisition systems and apparatuses that employ moving targets are well known and are typically used for exercise and training purposes. These systems and apparatuses are used in many different fields, ranging from dog training/exercise to sports training to military/police target practice. However, each of these systems and apparatuses are designed for a specific purpose. When designed as a dog training/exercise tool these types of devices encourage the dog to chase a moving object which allows the dog to not only get exercise and learn how to pursue an intended object, but it also allows the animal to maintain good psychological health by being playful. When designed as a sports training tool, such as with football, a quarterback may use the system to practice throwing and passing the football at a moving target to simulate a moving receiver. Additionally, when designed as a target practice tool, the shooter can practice shooting one or more targets under various tactical scenarios.

### SUMMARY OF THE INVENTION

An entertainment system including at least one support pole, at least one attachment cord, a motor, wherein the motor is associated with the support pole and the attachment cord and a target, wherein the target is connected to the attachment cord, and wherein the motor is operable to cause the target to move in at least one of a vertical direction, a horizontal direction and a circular direction relative to the at least one support pole via the attachment cord.

An entertainment system including at least one Remotely Controlled Vehicle (RCV) containing a vehicle processing device and a Remote Control Device (RCD) containing a control processing device, wherein the control processing device is communicated with the vehicle processing device to control the operation of the RCV, wherein the RCD and the RCV are configured to receive GPS coordinates, and wherein the RCD is configured to control and limit the location of the RCV to an entertainment space located within an entertainment space perimeter defined by a first set of GPS coordinates.

A method for implementing an entertainment system, wherein the entertainment system includes at least one Remotely Controlled Vehicle (RCV) containing a vehicle processing device and a Remote Control Device (RCD) containing a control processing device, wherein the control processing device is communicated with the vehicle processing device to control the operation of the RCV, wherein the RCD and the RCV are configured to receive GPS coordinates, and wherein the RCD is configured to control and limit the location of the RCV to an entertainment space located within an entertainment space perimeter defined by a first set of GPS coordinates. The method includes moving the RCD along the entertainment space perimeter to cause the RCD to receive a first set of GPS coordinates responsive to multiple locations along the entertainment space perimeter to define the entertainment space, storing the first set of GPS coordinates; communicating the first set of GPS coordinates to the RCV, locating the RCV within the entertainment space, powering up the RCV to cause the RCV to sense a second set of GPS coordinates responsive to a location of the RCV, comparing the first set of GPS coordinates with the second set of GPS coordinates to determine if the second set of GPS coordinates are within the first set of GPS coordinates and if the second set of GPS coordinates are within the first set of GPS coordinates, then operating the RCV to cause the RCV to controllably traverse the entertainment space, and if the second set of GPS coordinates are not within the first set of GPS coordinates, then preventing the RCV from being operated.

### BRIEF DESCRIPTION OF THE DRAWINGS

The foregoing and other features and advantages of the present invention should be more fully understood from the accompanying detailed description of illustrative embodiments taken in conjunction with the following Figures in which like elements are numbered alike:

FIG. 1A is a front perspective view of a gaming system, in accordance with one embodiment.

FIG. 1B is a perspective view of a gaming system, in accordance with one embodiment.

FIG. 2 is a top-down view of a gaming system, in accordance with another embodiment.

FIG. 3 is a top-down view of the gaming system of FIG. 2, in accordance with an embodiment.

FIG. 4A is a front perspective view of a gaming system, in accordance with still yet another embodiment.

FIG. 4B is a front perspective view of a control cord/pulley system/cord moving device set up for use in a gaming system, in accordance with an embodiment.

FIG. 5A is a front side view of a gaming system, in accordance with still yet another embodiment.

FIG. 5B is a front side view of a gaming system, in accordance with still yet another embodiment.

FIG. 6 is a perspective view of a gaming system, in accordance with still yet another embodiment.

FIG. 7 is a side view of a gaming poles for use with the gaming systems as disclosed herein, in accordance with another embodiment.

FIG. 8 is a isometric side view of a pulley cover for use with the gaming systems as disclosed herein, in accordance with another embodiment.

FIG. 9 is a side view of the pulley cover of FIG. 8, gaming system, in accordance with an embodiment.

FIG. 10 is a side view of the pulley cover of FIG. 8 and a target connecting device entering the pulley cover, in accordance with an embodiment.

FIG. 11A is a side view of the pulley cover of FIG. 8 and a target connecting device interacting with the pulley and pulley cover, in accordance with an embodiment.

FIG. 11B is a side view of the pulley cover of FIG. 8 and a target connecting device interacting with the pulley and pulley cover, in accordance with an embodiment.

FIG. 11C is a side view of the pulley cover of FIG. 8 and a target connecting device interacting with the pulley and pulley cover, in accordance with an embodiment.

FIG. 11D is a side view of the pulley cover of FIG. 8 and a target connecting device interacting with the pulley and pulley cover, in accordance with an embodiment.

FIG. 11E is a side view of the pulley cover of FIG. 8 and a target connecting device interacting with the pulley and pulley cover, in accordance with an embodiment.

FIG. 11F is a side view of the pulley cover of FIG. 8 and a target connecting device interacting with the pulley and pulley cover, in accordance with an embodiment.

FIG. 12 is a front view of a house/building/land associated with an entertainment system, in accordance with an embodiment.

FIG. 13 is a top-down view of a house/building/land associated with an entertainment system, in accordance with an embodiment.

FIG. 14 is a front view of a house/building/land associated with an entertainment system, in accordance with an embodiment.

FIG. 15 is a top-down view of a house/building/land associated with an entertainment system, in accordance with an embodiment.

FIG. 16 is a top-down view of a vehicle for use with an entertainment system, in accordance with an embodiment.

FIG. 17 is a top-down view of a vehicle for use with an entertainment system, in accordance with an embodiment.

### DETAILED DESCRIPTION

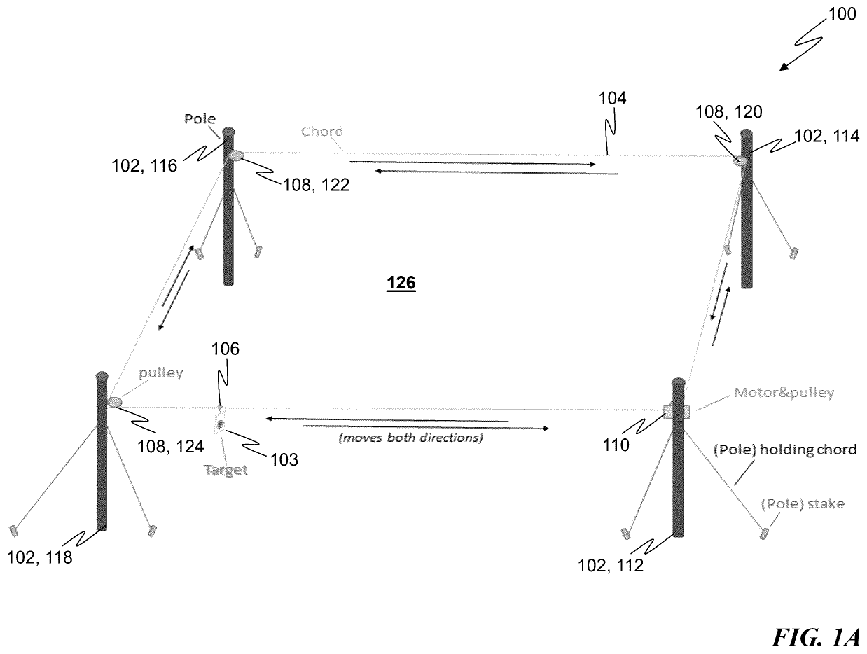

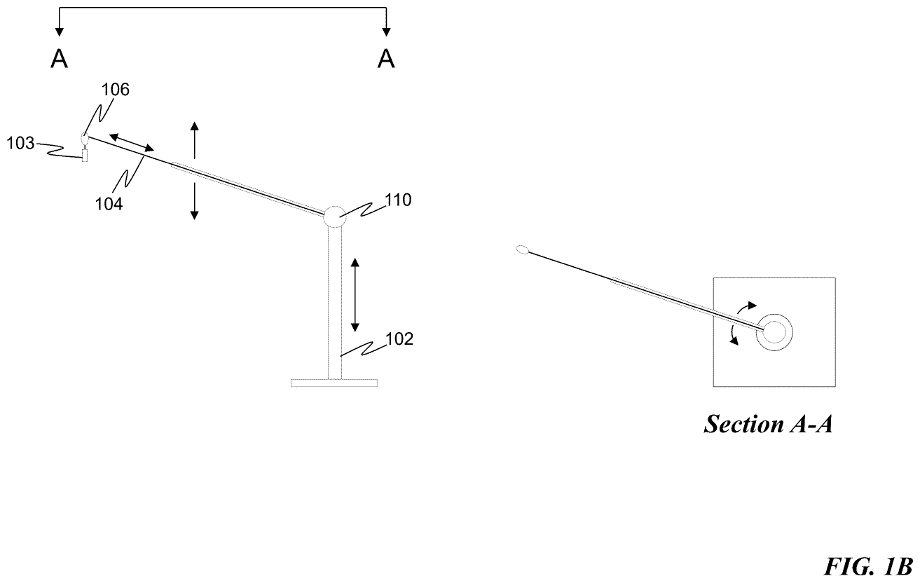

Referring to FIG. 1A, a gaming system 100 which allows for a two (2) dimensional physical gaming experience is provided in accordance with an embodiment. The gaming system 100 includes a plurality of game poles 102, a target 103, at least one target cord 104 having at least one target connection device 106, a plurality of pulleys 108 and a target cord moving device 110, wherein the target cord moving device 110 may include a moving device pulley 108 and a motor for causing the target cord 104, and thus the target 103, to traverse a game space 126 and/or an edge of the game space 126. The plurality of game poles 102 include a control pole 112, a first game pole 114, a second game pole 116 and a third game pole 118 and the plurality of pulleys 108 include a first pulley 120, a second pulley 122 and a third pulley 124. It should be appreciated that each of the plurality of game poles 102 are configured to be secured to a suitable stable base (e.g., the ground, a platform, a floor (if located in a building)) and to extend upward from the base and be spaced apart and arranged to define the game space 126 having a game space shape. In other embodiments, the plurality of game poles 102 may be stand-alone game poles 112, 114, 116, 118 that may not be secured to any base, but rather they may include a weighted pole bottom and may have a low center of gravity (e.g., close to the bottom of the game pole) to keep the pole stable. Additionally, in another embodiment, in order for the game poles 112, 114, 116, 118 to be stable, the game poles 112, 114, 116, 118 may be designed to be sufficiently wide and heavy proximate to the bottom of the game pole 112, 114, 116, 118 and/or they may be stabilized by a heavy/weighted base connected to the bottom of the game pole 112, 114, 116, 118. The first pulley 120 is securely associated with the first game pole 114, the second pulley 122 is securely associated with the second game pole 116, the third pulley 124 is securely associated with the third game pole 118 and the target cord moving device 110 is securely associated with the control pole 112. The target cord 104 is movably associated with the first pulley 120, the second pulley 122, the third pulley 124 and the target cord moving device 110, such that when the target cord moving device 110 is operated, the target cord 104 traverses the game space via the plurality of pulleys 108.

Accordingly, as the target cord 104 traverses the game space 126, the target connection device 106, and any target 103 attached to the target connection device 106, also traverses the game space 126. As shown in FIG. 1, as the target cord moving device 110 is operated, the target connection device 106 and the attached target 103, moves through the plurality of pulleys 108 to traverse the peripheral of the game space 126. It should be appreciated that the target cord moving device 110 may be controlled via a remote device (and its associated electronics), such as a remote controller, a PDA, smart phone, laptop, tablet, etc., having an application installed thereon and/or via a controller integrated with the target cord moving device 110. Additionally, the target cord moving device 110 may be powered via a battery and/or a direct connection with an external power source.

It should be appreciated that in other embodiments, the plurality of game poles 102 may include any number of game poles 102 as desired and the plurality of pulleys 108 may include any number of pulleys 108 as desired. Moreover, although only one target cord moving device 110 is illustrated, it is contemplated that multiple target cord moving devices 110 may be used as desired. Additionally, one or more of the plurality of poles may be height adjustable (controllably and statically adjustable and/or dynamically adjustable) to provide a static/dynamic three-dimensional game space 126. Furthermore, the plurality of game poles 102 may include one or more game poles 102 as desired and may be configurable to form any shape pattern of game space 126 as desired, such as rectangular, circular, octagonal, etc, where each of the game poles 102 may be adjusted to different heights from the other game poles 102. Referring to FIG. 1B, it should be appreciated that when only one game pole 102 is used, the game pole 102 may include one or more rigid target cords 104 which may extend outward and/or upward from the game pole 102 and a target cord moving device 110 which is operable to cause the target cord 104 and any target 103 attached to the target cord 104 to move in a circular fashion around the game pole 102 and/or move in a vertical fashion (simultaneously or non-simultaneously). Additionally, the height of the game pole 102 may be configured to be static and/or dynamically adjustable. Furthermore, the speed and direction of the target cord 104, and thus the target 103 connected to the target cord 104, may be adjustable as desired. For example, the target cord 104 may be controlled to stop periodically and then start again with no warning.

It is further contemplated that in other embodiments, the gaming system 100 may include multiple target cords 104, multiple target connection devices 106 and multiple target cord moving devices 110, to allow multiple targets 103 to controllably traverse the game space 126 to allow multiple players to play simultaneously.

It should be appreciated that the gaming system 100 may be used for one or more players to “shoot” at a target(s) 103 as the target(s) 103 traverses the game space 126. The player(s) may “shoot” the target(s) using any type of “shooting” device, such as a laser gun (which emits an electromagnetic beam), a water gun (which emits a fluid stream), an airsoft gun, a paintball gun, etc (which emits a kinetic projectile). Moreover, in an embodiment, the target(s) 103 (and/or target connection device(s) 106) may be configured to “sense” when the target(s) 103 have been “shot” by a shooting device (and where on the target(s) the target(s) was hit). This gaming system 100 and the target(s) 103 (and/or target connection device(s) 106) may be in communication with each other such that when the target(s) 103 (and/or target connection device(s) 106) “sense” that the target(s) 103 have been “shot”, the gaming system 100 may add a point and/or subtract a point. Additionally, upon being “shot”, the gaming system 100 may cause the target(s) 103 to move erratically (e.g., move faster, stop unexpectedly, change travel speed and/or direction, change height, etc.) to provide more challenge to the player(s).

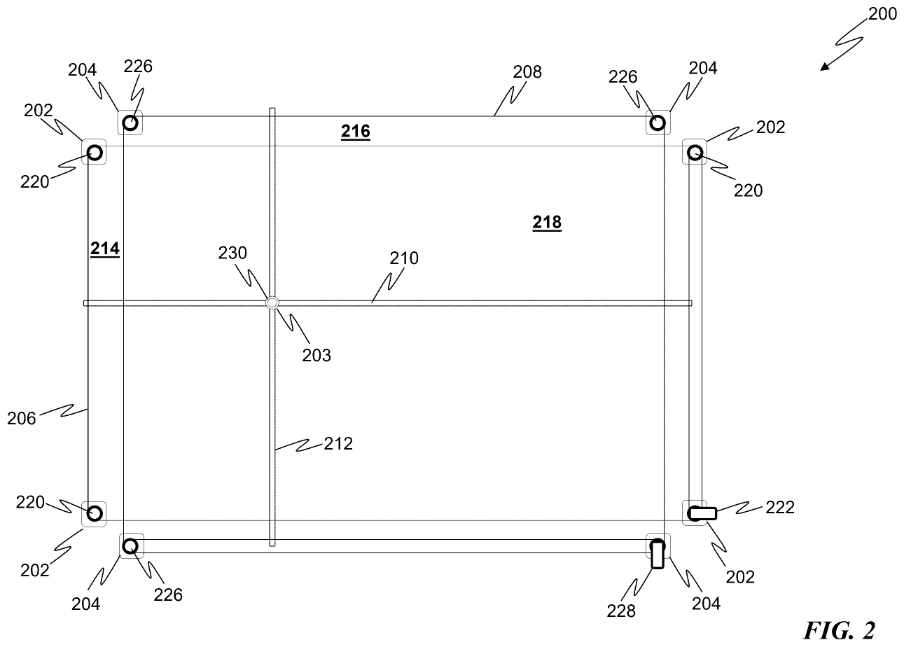

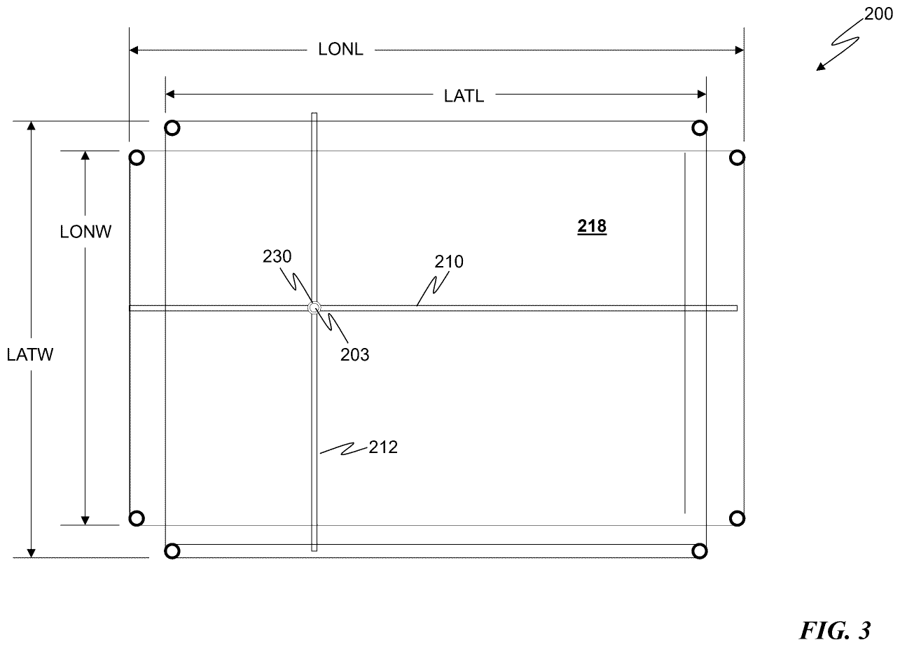

Referring to FIG. 2 and FIG. 3, a gaming system 200 which allows for a multi-dimensional (e.g., 2-dimensional, 3-dimensional, etc.) physical gaming experience is provided, in accordance with another embodiment. The gaming system 200 includes a plurality of longitudinal game poles 202, a plurality of latitudinal game poles 204, at least one longitudinal target cord 206, at least one latitudinal target cord 208, a longitudinal target guideline 210 and a latitudinal target guideline 212. According to an embodiment, the plurality of longitudinal game poles 202 may include four (4) longitudinal game poles 202 which are arranged to stably extend upwardly from a base, such as the ground, a platform or a floor (if indoors) to define a longitudinal game space 214 having a length LONL and a width LONW. The plurality of latitudinal game poles 204 may include four (4) latitudinal game poles 204 which are arranged to stably extend upwardly from a base, such as the ground, a platform or a floor (if indoors) to define a latitudinal game space 216 having a length LATL and a width LATW. The four (4) longitudinal game poles 202 and the four (4) latitudinal game poles 204 are arranged relative to each other such that the longitudinal game space 214 and the latitudinal game space 216 are overlapping to define a common game space 218 having a substantially rectangular (or square) shape located between the four (4) longitudinal game poles 202 and the four (4) latitudinal game poles 204.

It should be appreciated that in other embodiments, the plurality of longitudinal game poles 202 may include more or less than four (4) game poles 202 and the plurality of latitudinal game poles 204 may include more or less than four (4) latitudinal game poles 204, as desired. Additionally, the longitudinal poles 202 and latitudinal poles 204 may have the same or similar designs to each other and may be interchangeable with each other. The gaming system 200 further includes a plurality of longitudinal pulleys 220 (in this embodiment, three (3) longitudinal pulleys 220), at least one longitudinal target cord moving device 222, a plurality of latitudinal pulleys 226 (in this embodiment, three (3) latitudinal pulleys 226) and at least one latitudinal target cord moving device 228.

It should be appreciated that a longitudinal pulley 220 may be securely associated with each of three of the longitudinal game poles 202 and the longitudinal target cord moving device 222 may be securely associated with the remaining longitudinal game pole 202. In a similar fashion, a latitudinal pulley 226 may be securely associated with each of three of the latitudinal game poles 204 and the latitudinal target cord moving device 228 may be securely associated with the remaining latitudinal game pole 204. Moreover, the longitudinal target cord 206 may be associated with each of the three longitudinal pulleys 220 and the longitudinal target cord moving device 222 and the latitudinal target cord 208 may be associated with each of the three latitudinal pulleys 226 and the latitudinal target cord moving device 228. It should be further appreciated that the longitudinal target guideline 210 may be connected to the longitudinal target cord 206 on both sides of the longitudinal game space 214 to divide the longitudinal game space 214 and the latitudinal target guideline 212 may be connected to the latitudinal target cord 208 on both sides of the latitudinal game space 216 to divide the latitudinal game space 216. It should be appreciated that the gaming system 200 may further include a target connection device 230 configured to connect to a target 203, which is movably associated with both the longitudinal target guideline 210 and the latitudinal target guideline 212, such that when the longitudinal target cord moving device 222 is operated to move the longitudinal target cord 206 and the latitudinal target cord moving device 228 is operated to move the latitudinal target cord 208, the target connection device 230 moves within the common game space 218.

Thus, as the longitudinal target cord moving device 222 is operated, the longitudinal target cord 206 moves around and traverses the four longitudinal game poles 202 and through the three longitudinal pulleys 220 and the longitudinal target cord moving device 222. This causes the longitudinal target guideline 210 and the target connection device 230 to move within the longitudinal game space 214 in the direction of the longitudinal width LONW. Similarly, as the latitudinal target cord moving device 228 is operated, the latitudinal target cord 208 moves around and traverses the four latitudinal game poles 204 and through the three latitudinal pulleys 226 and the latitudinal target cord moving device 228. This causes the latitudinal target guideline 212 and the target connection device 230 to move within the latitudinal game space 216 in the direction of the latitudinal length LATL. When both the longitudinal target cord moving device 222 and the latitudinal target cord moving device 228 are operated together, this causes the target connection device 230 to move back and forth (longitudinally and latitudinally) within the common game space 218.

Accordingly, as the longitudinal target cord 206 and the latitudinal target cord 208 traverses the common game space 218, the target connection device 230, and any target 203 attached to the target connection device 230, also traverses the common game space 218. As shown in FIG. 2 and FIG. 3, as the longitudinal target cord moving device 222 and the latitudinal target cord moving device 228 is operated, the target connection device 230 and the attached target 203, moves through-out the common game space 218. It should be appreciated that the longitudinal target cord moving device 222 and the latitudinal target cord moving device 228 may be controlled via a remote controller (processing device) and/or via a controller (processing device) integrated with the longitudinal target cord moving device 222 and the latitudinal target cord moving device 228. Additionally, the longitudinal target cord moving device 222 and the latitudinal target cord moving device 228 may be powered via a battery and/or a direct connection with an external power source.

It should be appreciated that in other embodiments, the plurality of longitudinal game poles 202 may include four (4), or more/less, longitudinal game poles 202 and the plurality of latitudinal game poles 204 may include four (4), or more/less, latitudinal game poles 204 as desired. Moreover, the at least one longitudinal target cord moving device 222 and the at least one latitudinal target cord moving device 228 may include any number of longitudinal target cord moving devices 222 and latitudinal target cord moving devices 228 as desired and as suitable to the desired end purpose. Additionally, one or more of the plurality of longitudinal game poles 202 and/or latitudinal game poles 204 may be manually or dynamically height adjustable (controllably and statically adjustable and/or dynamically adjustable via a processing device) to provide a static/dynamic three dimensional game space 126. Furthermore, the speed and direction of the target connection device 230, and thus the target 203 connected to the target connection device 230, may be adjustable as desired. For example, longitudinal target cord moving devices 222 and latitudinal target cord moving devices 228 may be controlled to, simultaneously or non-simultaneously, change direction, height, speed up and slow down and/or to stop periodically and then start again with no warning to provide a more challenging interactive experience.

It should be appreciated that the gaming system 200 may be used for a player to “grab and pull” a target 203 off of the target cord or holder and/or “shoot” at a target 203 as the target 203 traverses the common game space 218. The player(s) may “shoot” the target using any type of “shooting” device, such as a laser gun, a water gun, an airsoft gun, a paintball gun, etc. Moreover, in an embodiment, the target 203 (and/or target connection device 230) may include a processing device and/or sensor to and may be configured to “sense” when the target 203 has been “shot” by a shooting device (and where on the target 203 the target 203 was hit). This gaming system 200 and the target 203 (and/or target connection device 230) may be in communication with each other such that when the target 203 (and/or target connection device 230) “senses” that the target 203 has been “shot”, the gaming system 200 may add a point and/or subtract a point. Additionally, upon the target 203 being “shot”, the gaming system 200 may cause the target 203 to move erratically (e.g., move faster, stop unexpectedly, change travel speed and/or direction, change height, etc.) to provide more challenge to the player(s). Additionally, the gaming system 200 may include a scoring system that responds (i.e., makes noise, increments, etc) every time the target has “sensed” being ‘shot’.

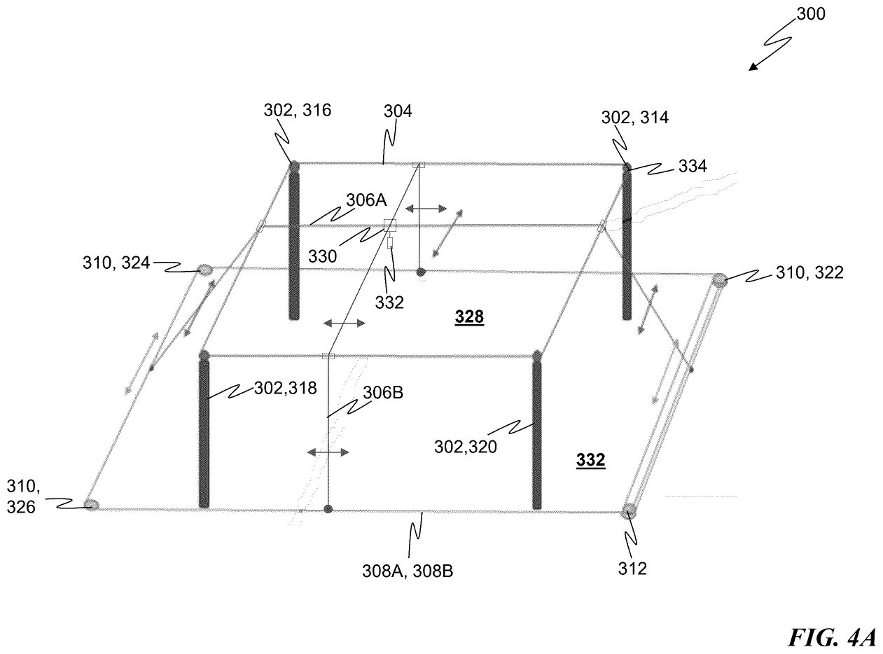

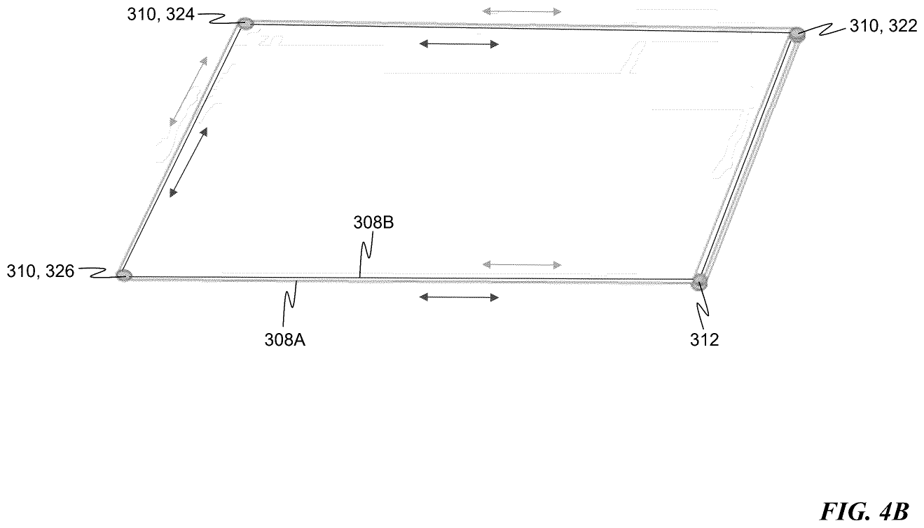

Referring to FIG. 4A and FIG. 4B, a gaming system 300 which allows for a two (2) dimensional physical gaming experience is provided in accordance with yet another embodiment. The gaming system 300 includes a plurality of game poles, a supporting cord 304, a first target cord 306A, a second target cord 306B, a first control cord 308A, a second control cord 308B, a plurality of cord pulleys 310 and a cord moving device 312. It should be appreciated that the plurality of game poles 302 include a first game pole 314, a second game pole 316, a third game pole 318 and a fourth game pole 320 and the plurality of cord pulleys 310 include a first pulley 322, a second pulley 324 and a third pulley 326. Each of the plurality of game poles 302 are configured to be secured to the ground (or platform or a floor, if in a building) and to extend upward from the ground. Additionally, each of the plurality of game poles 302 are spaced apart from each other and arranged to define a game space 328 located between the plurality of game poles 302. It should be appreciated that the plurality of game poles 302 may be arranged such that the game space 328 may be of any shape desired, such as, for example a rectangular (or square) shape. Furthermore, in another an embodiment, one or more of the plurality of game poles 302 are configured to increase or decrease in height to allow for a 3-dimensional gaming experience.

Moreover, the cord moving device 312 is associated with and configured to move each of the first control cord 306A and the second control cord 306B independently of each other. Additionally, each of the plurality of cord pulleys 310 are configured to associate with the first control cord 306A and the second control cord 306B such that the first control cord 306A and the second control cord 306B are able to move independent from each other. This allows the gaming system 300 to position the intersection of the first control cord 306A and the second control cord 306B anywhere within the game space 328. The first pulley 322 is securely associated with the ground to be located adjacent the first game pole 314, the second pulley 324 is securely associated with the ground to be located adjacent the second game pole 316, the third pulley 326 is securely associated with the ground to be located adjacent the third game pole 318 and the cord moving device 312 is securely associated with the ground to be located adjacent the fourth game pole 320. Additionally, the game system 300 includes a target pulley 330 configured to connect to a target 332 and associated with each of the first control cord 306A and the second control cord 306B to allow the target pulley 330 to independently move along each of the first control cord 306A and the second control cord 306B.

It should be appreciated that the supporting cord 304 is securely and non-movably associated with a top portion 334 of each of the four game poles 302 to surround the perimeter of the game space 328. Each of the first control cord 308A and the second control cord 308B is movably associated with each of the three cord pulleys 310 and the cord moving device 312 to define a pulley space 332, wherein the four game poles 302 (and game space 328) are located within the pulley space 332. One end of the first target cord 306A is securely connected to the first control cord 308A on a first side of the game space 328 and the other end of the first target cord 306A is securely connected to the first control cord 308A on the second side of the game space 328 opposite the first side, such that the first target cord 306A is resting on the supporting cord 304. Similarly, one end of the second target cord 306B is securely connected to the second control cord 308B on a third side of the game space 328 and the other end of the second target cord 306B is securely connected to the second control cord 308B on a fourth side of the game space 328 opposite the third side, such that the second target cord 306B is resting on the supporting cord 304. Accordingly, the first target cord 306A is arranged to be perpendicular to the second target cord 306B, and when the cord moving device 312 is operated, the cord moving device 312 causes the first target cord 306A to move back and forth along the first and second sides of the game space 328 and the second target cord 306B to move back and forth along the third and fourth sides of the game space 328. This allows the target 332 to move anywhere within the game space 328. It should be appreciated that the cord moving device 312 may be powered via a battery, a solar source and/or a direct electrical connection with an external power source.

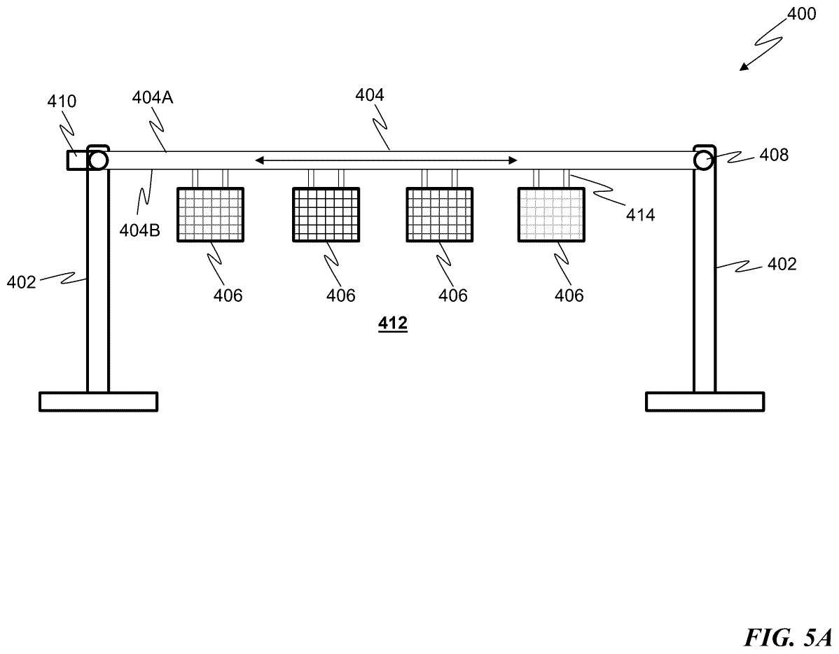

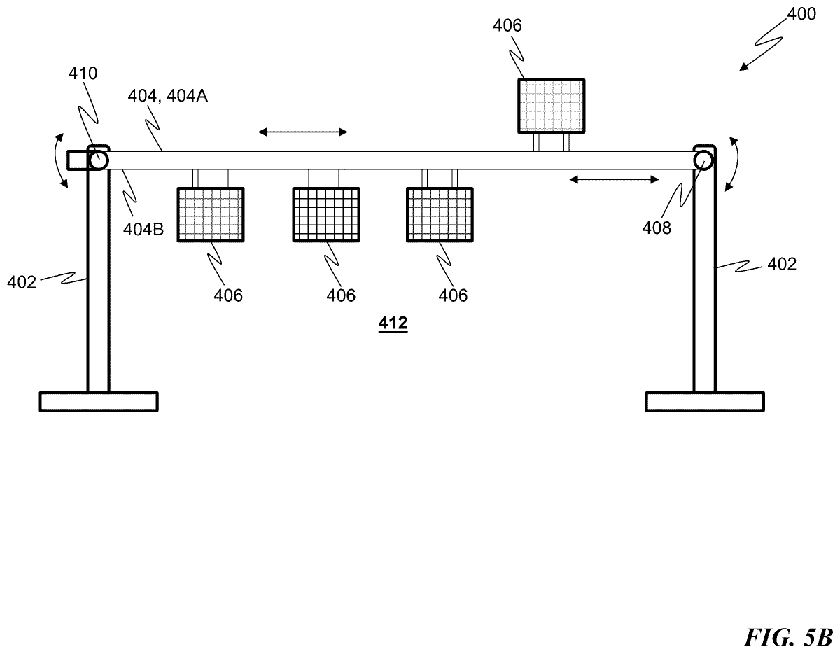

Referring to FIG. 5A and FIG. 5B, a gaming system 400 which allows for a one (1) dimensional physical gaming experience is provided in accordance with still yet another embodiment of the invention. The gaming system 400 includes a plurality of game poles 402 (in this embodiment two (2) or more game poles 402), a target cord 404, one or more targets 406, at least one (1) cord pulley 408 and at least one (1) cord moving device 410. Each of the game poles 402 are configured to be secured to the ground (or floor, if in a building) and to extend vertically upward from ground level and be spaced apart and arranged to define a game space 412 between the game poles 402. In other embodiments, the game poles 402 may be stand-alone game poles 402 that may not be secured to any platform and that may be weighted and have a low center of gravity (e.g., close to the bottom of the game pole). Additionally, the game poles 402 may be designed to be sufficiently wide proximate the bottom of the game pole 402 and/or that may be stabilized by a heavy/weighted base connected to the bottom of the game pole 402. It should be appreciated that the cord pulley 408 is securely associated with one of the game poles 402 and the cord moving device 410 is securely associated with the other game pole 402. Moreover, the target(s) 406 (such as a net) may be securely associated with the target cord 404 via one or more target connection devices 414 and the target cord 404 is movably associated with the cord pulley 408 and the cord moving device 410. It should be further appreciated that the target cord 404 and the cord moving device 410 are configured such that when the cord moving device 410 is operated, the targets 406 move back and forth between the two game poles 402. Additionally, in another embodiment, the target cord 404 includes a target cord upper portion 404A and a target cord lower portion 404B. The cord moving device 410 is configured such that when the cord moving device 410 is operated, the target cord 404 moves in a circular fashion between the game poles 402 such that the targets 406 move along the target cord upper portion 404A and the target cord lower portion 404B. In still yet another embodiment, it is contemplated that the one or more of the game poles 402 may be configured to be controllably increasable and/or decreasable in height. This may be accomplished via a manual approach and/or by using a remote/programmable controller.

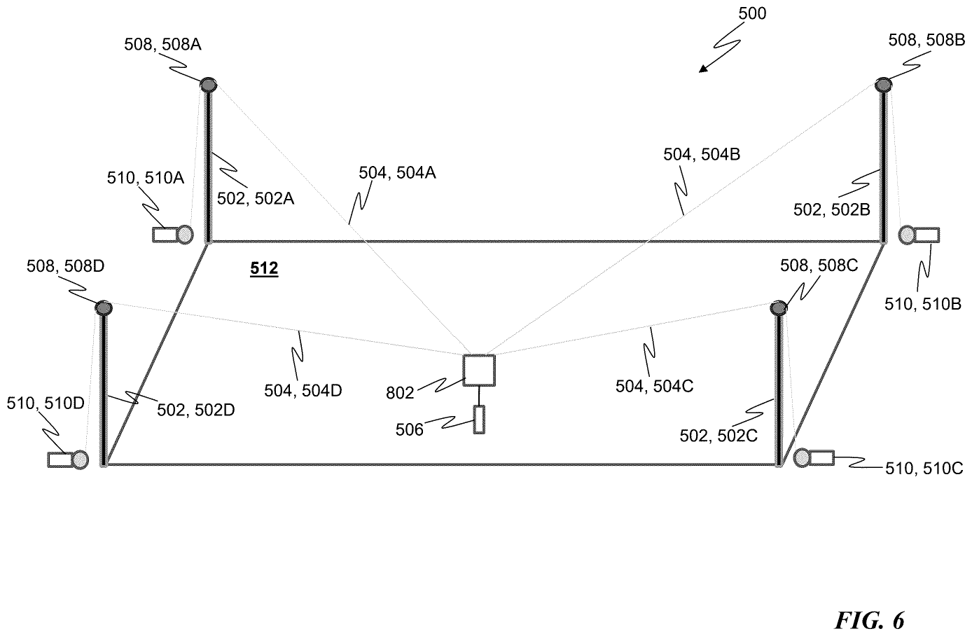

Referring to FIG. 6, a gaming system 500 which allows for a two (2) or three (3) dimensional physical gaming experience is provided, in accordance with still yet another embodiment of the invention. The gaming system 500 includes a plurality of game poles 502, a plurality of target cords 504, a target/object 506, a plurality of cord pulleys 508 and a plurality of cord moving devices 510. The plurality of game poles 502 may be spaced apart from each other and arranged to define a game space 512 disposed between the plurality of game poles 502. The plurality of game poles 502 may include a first game pole 502A, a second game pole 502B, a third game pole 502C and a fourth game pole 502D. The plurality target cords 504 may include a first target cord 504A, a second target cord 504B, a third target cord 504C and a fourth target cord 504D. The plurality of cord pulleys 508 may include a first cord pulley 508A, a second cord pulley 508B, a third cord pulley 508C and a fourth cord pulley 508D. The plurality of cord moving devices 510 may include a first cord moving device 510A, a second cord moving device 510B, a third cord moving device 510C and a fourth cord moving device 510D.

As shown in FIG. 6, the first game pole 502A is associated with first target cord 504A, the first cord pulley 508A and the first cord moving device 510A, such that first target cord 504A is moveably associated with the first cord pulley 508A, where one end of the first target cord 504A is securely connected to the first cord moving device 510A and the other end of the first target cord 504A is securely connected to the target/object 506. Similarly, the second game pole 502B is associated with second target cord 504B, the second cord pulley 508B and the second cord moving device 510B, such that second target cord 504B is moveably associated with the second cord pulley 508B, where one end of the second target cord 504B is securely connected to the second cord moving device 510B and the other end of the second target cord 504B is securely connected to the target/object 506.

Moreover, the third game pole 502C is associated with third target cord 504C, the third cord pulley 508C and the third cord moving device 510C, such that third target cord 504C is moveably associated with the third cord pulley 508C, where one end of the third target cord 504C is securely connected to the third cord moving device 510C and the other end of the third target cord 504C is securely connected to the target/object 506. Furthermore, the fourth game pole 502D is associated with fourth target cord 504D, the fourth cord pulley 508D and the fourth cord moving device 510D, such that fourth target cord 504D is moveably associated with the fourth cord pulley 508D, where one end of the fourth target cord 504D is securely connected to the fourth cord moving device 510D and the other end of the fourth target cord 504D is securely connected to the target/object 506.

According to this configuration, the target/object 506 is moveably disposed within the game space 512 and connected to each of the first target cord 504A, second target cord 504B, third target cord 504C and fourth target cord 504D, such that when one or more of the first target cord 504A, second target cord 504B, third target cord 504C and/or fourth target cord 504D are controllably moved, the target/object 506 is movable throughout the entire game space 512. For example, if the first cord moving device 510A winds the first target cord 504A into the first cord moving device 510A, the second cord moving device 510B winds the second target cord 504B into the second cord moving device 510B and the third cord moving device 510C unwinds the third target cord 504C and the fourth cord moving device 510D unwinds the fourth target cord 504D then the target/object 506 is moved to one side of the game space 512. On the other hand, if the first cord moving device 510A winds the first target cord 504A into the first cord moving device 510A, the third cord moving device 510C winds the third target cord 504C into the third cord moving device 510C and the second cord moving device 510B unwinds the second target cord 504B and the fourth cord moving device 510D unwinds the fourth target cord 504D, the target/object 506 is moved to center of the game space 512. In this way, controlling the operation of the plurality of cord moving devices 510 to control the winding and unwinding movement of the plurality of target cords 504 allows the target/object 506 to be controllably positionable anywhere within the game space 512.

It should be appreciated that an embodiment uses four (4) spools of cord that can wind or unwind via motorized cord moving devices 510A, 510B, 510C, 510D to move the target 506 anywhere over a given area defined by the poles 502 (e.g., the game space 512), where the ends of each of the target cords 504 are tightly fastened to the target connecting device 802. Moreover, the system can change the target's speed, height, latitudinal direction and longitudinal direction as desired. This system also allows for control of the target elevation by controlling the amount of slack in the target cord 504 or by having height adjustable poles 502. It should be further appreciated that the target cord 504 may be movable in a first direction and a second direction and wherein the motor is 110 is operable to move the target cord around the perimeter of the entertainment space in at least one of the first direction and the second direction at a target cord speed, wherein the target cord speed is controllably variable in a speed range between 0 miles per hour and about 35 miles per hour±10%.

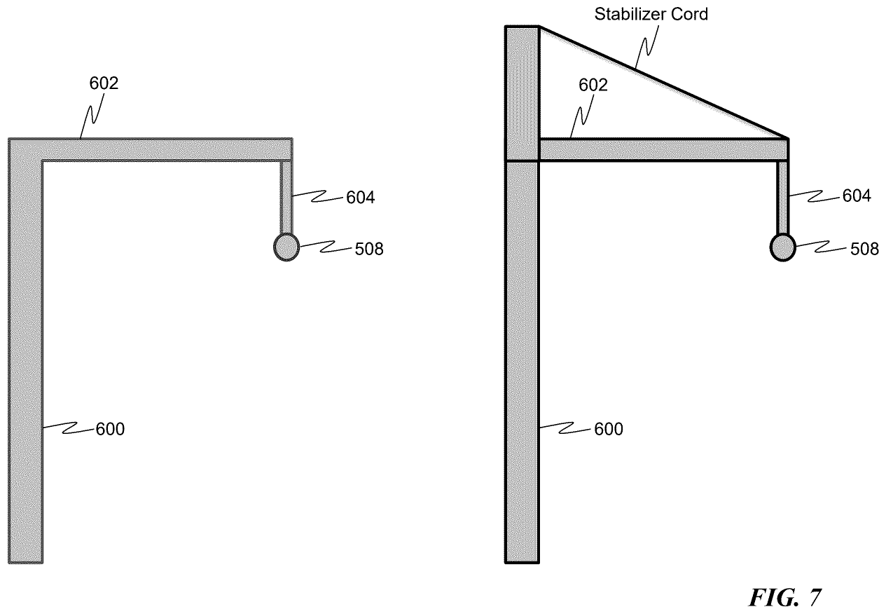

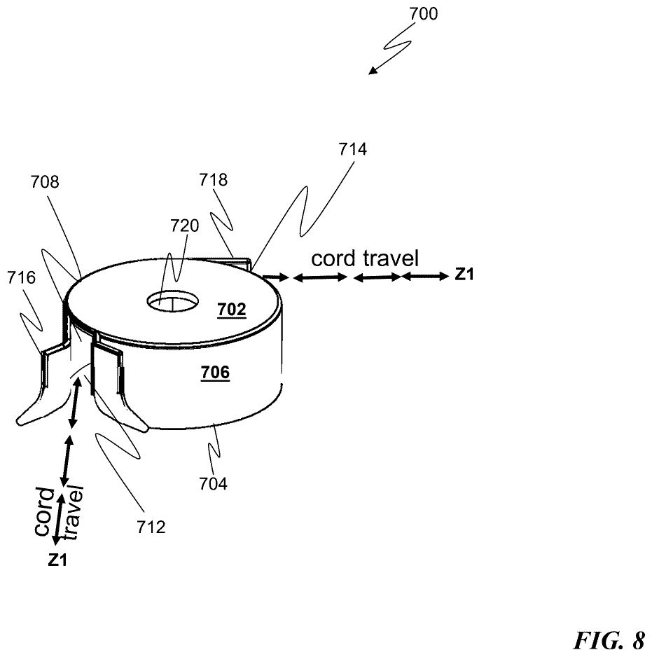

Referring to FIG. 7, another embodiment of the plurality of game poles 600 are shown, where each of the game poles 600 includes a support 602 and a pulley support 604 extending from the game pole 600, where the cord pulley 508 is securely associated with the substantially horizontal support 602. It should be appreciated that the substantially horizontal support 602 may prevent the target/object 512 from hitting/colliding with the game poles 600 as the target/object 512 approach the pulleys. In still yet another embodiment, a pully cover and/or ‘guide’ (See FIG. 8) may be used to prevent the target/object 512 from colliding with the game poles 600. One advantage to these configurations allows the pulleys to be disposed closer to the game poles 600 thereby reducing structural stress on the game poles 600.

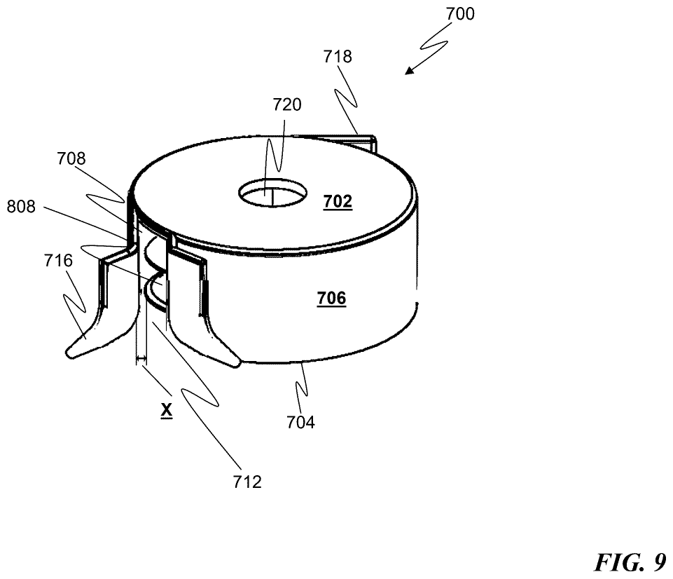

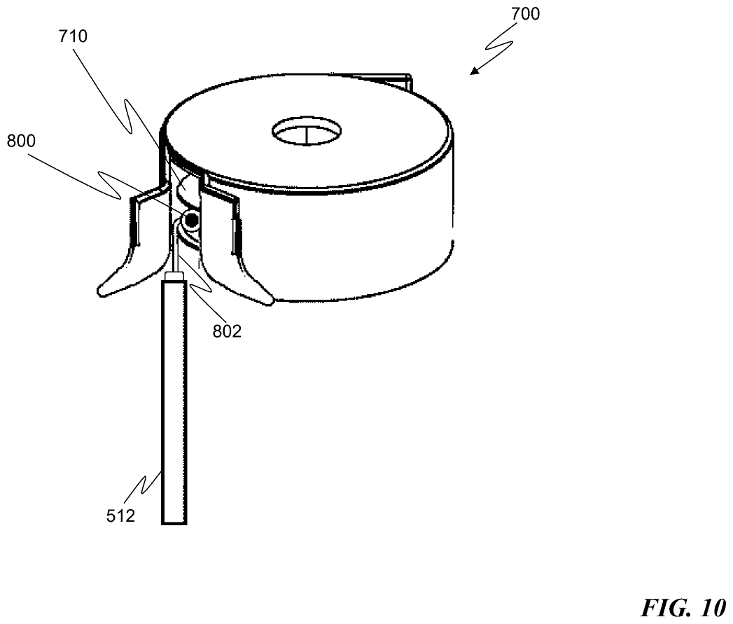

Referring to FIG. 8, FIG. 9 and FIG. 10 an embodiment of a pully cover 700 is shown and includes a cover top 702, a cover bottom 704 and a cover side 706, where the pulley cover 700 defines a cover cavity 708 for containing a pulley 710 therein. The cover side 706 defines a first cover opening 712 communicated with the cover cavity 708, a second cover opening 714 communicated with the cover cavity 708, a first cover opening guide 716 associated with the first cover opening 712 and a second cover opening guide 718 associated with the second cover opening 714. Additionally, the pulley cover 700 defines a center cavity 720 which communicates the cover top 702 with the cover bottom 704. The pully cover 700 is configured to securely contain the pulley 710 such that a target cord associated with the pulley 710 may movably traverse both the first cover opening 712 and the second cover opening 714. Moreover, the pulley cover 700 may be securely associated with a game pole 600 via a pulley axle that may be associated with the pully cover 700 (and the pulley 710 contained therein) by disposing the pulley axle within the center cavity 720. It should be appreciated that the cover cavity 708 is sized to contain the pulley 710 such that a space X is disposed between the inner wall of the cover side 706 and the pulley 710. This configuration allows a target connector 802 that is connected to a target cord 800 to traverse the pulley cover 700 as the target cord 800 is being pulled through the pulley 710 without interfering with the movement of the target cord 800 and the target/object 506 connected to the target cord 800 via the target connector 802.

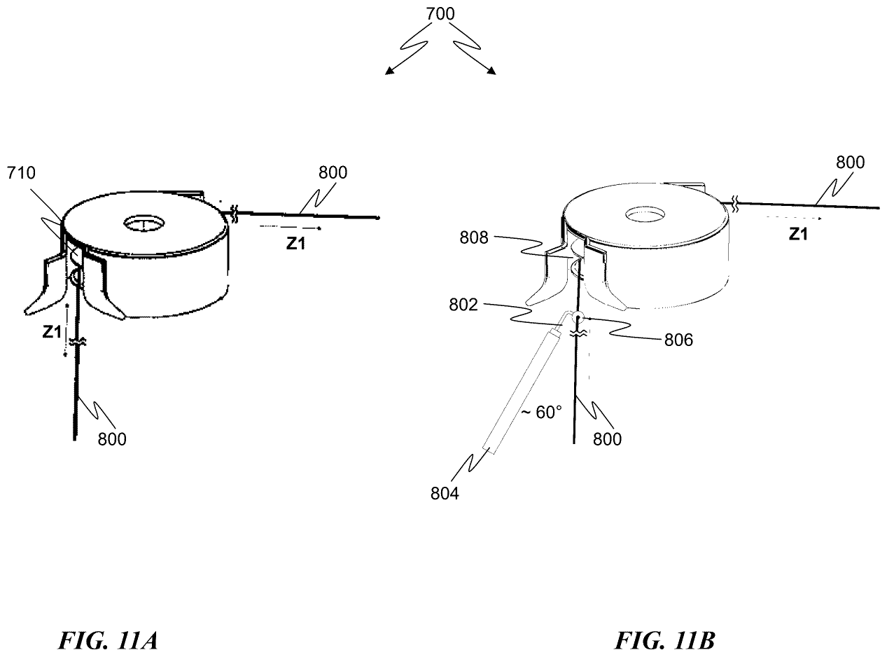

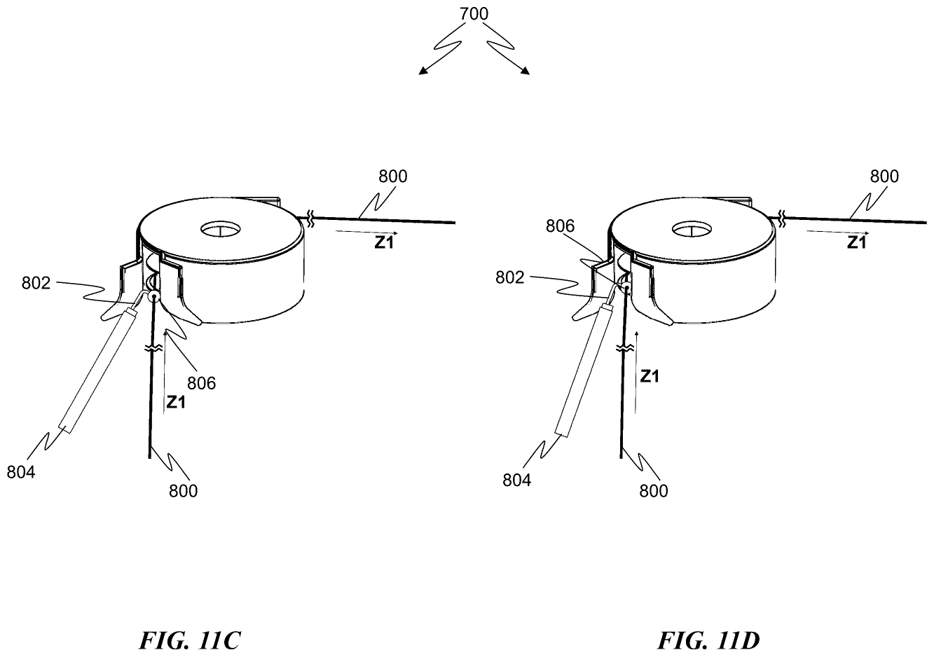

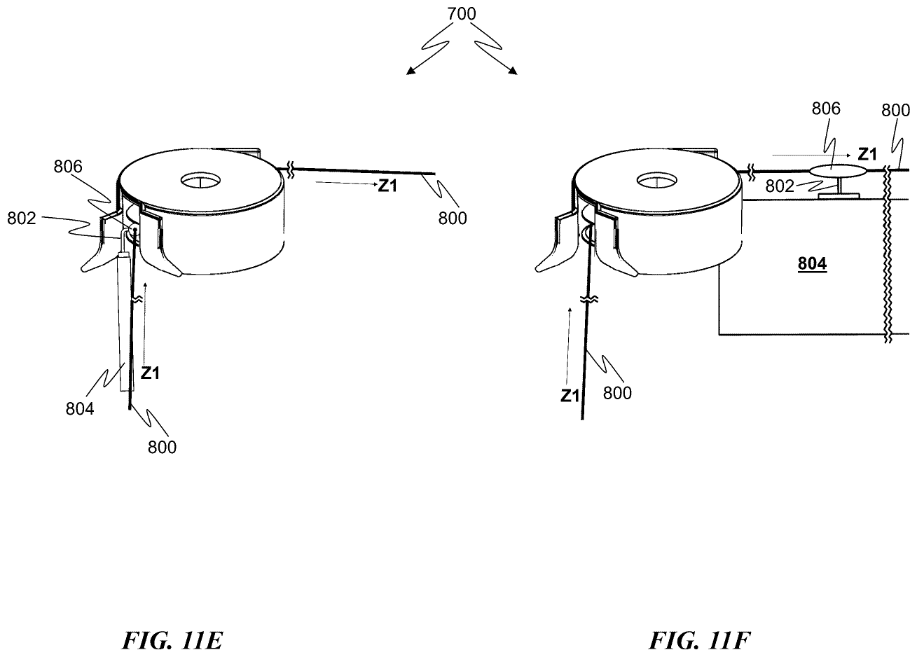

Referring to FIG. 11A, a pulley cover 700 is shown having a pulley 710 contained therein with a target cord 800 associated with the pulley 710 to moveably traverse the first cover opening 712 and the second cover opening 714. Referring to FIG. 11B-E, as the target cord 800 is moved in a direction Z1 the target cord 800 enters the first cover opening 712 and exits the second cover opening 714. As shown, a target 804 attached to the target connector 802 which is connected to the target cord 800 moves along with the target cord 800 toward the pulley 710 and the pulley cover 700. Referring to FIG. 11C, as the target connector 802 encounters the pulley cover 700 and the pulley 710, the target connector 802 is guided into the cover cavity 708 via the first cover opening 712 by the first cover opening guide 716 such that the target connector 802 movably interacts with the pulley 710. It should be appreciated that the target connector 802 may have a connector head 806 that is sized to movably fit into the pulley trench 808 which is containing the target cord 800 as the target cord 800 and the target connector 802 move through the pulley 710, such that the target 804 extends downwardly out of the bottom of the pulley cover 700 as the target cord 800 and the target connector 802 move through the pulley 710. At this point, in an embodiment, the target 802 is angled at an angle of about 60 degrees from vertical. Additionally, the space between the inner wall of the cover side 706 and the pulley 710 is sized to allow the target connector 802 to move along the pulley 710 with the target cord 800 and to exit out of the second cover opening 714, as shown in FIG. 11F. Additionally, as the target connector 802 moves into pulley 710, the target 804 rotates into a near vertical orientation (e.g., ˜0 degrees) and remains in the near vertical orientation until the target exists the pulley cover 700. Essentially, as the target 804 moves to the pulley 710, the guides 716, 718 contact the target connector 802 to vertically align the target 804 so that the target 804 becomes substantially perpendicular to the side of the pulley 710 in order to allow the target connector 802 to go around the pulley 710 with more easily.

It should be appreciated that the pulley cover 700 protects the pulley from dirt, debris, and weather. Moreover, the pulley cover 700 may include brushes proximate the first cover opening 712 and the second cover opening 714 to ‘brush’ any dirt or debris off of the target cord 800 or the target connector 802 as the target cord 800 and/or the target connector 802 enter the cover cavity 708. Additionally, the pulley cover 700 helps to prevent objects (e.g., hair, fingers, clothing, etc.) from getting caught in the pulley 710. Furthermore the pulley cover 700 helps to orient the target 804 and/or the target connector 802 to be substantially perpendicular to the pulley 710 to prevent the target 804 from hitting the support pole.

It should be appreciated that in other embodiments, the plurality of game poles 102, 202, 204, 302, 402, 502, 600 may include any number of game poles 102, 202, 204, 302, 402, 502, 600 as desired and they may be arranged to form any pattern of game space 126, 216, 328, 412, 512 as desired, such as rectangular, circular, octagonal, etc. Moreover, it should be further appreciated that in other embodiments, the height of the game poles 102, 202, 204, 302, 402, 502, 600 may be controllably adjustable, individually or together, so that a target connected to the target connection device 106, 230, 414, 802 can be movable in multiple dimensions. Furthermore, it is contemplated that certain elements of the game systems 100, 200, 300, 400, 500, 1000 may be replaced with or used in conjunction with other elements (for example, linear bearings may be used along with or in place of pulleys).

Moreover, it should also be appreciated that in other embodiments each of the game systems 100, 200, 300, 400, 500, 1000 (including the elements of each of the game systems 100, 200, 300, 400, 500, 1000) may be manually controllable or controllable via a programmable control device/processing device. Additionally, each of the game systems 100, 200, 300, 400, 500, 1000 having a programmable control device may include a recording/learning mode, where after a player plays multiple games, the controller ‘learns’ how the player reacts to actions of the game system 100, 200, 300, 400, 500, 1000 and dynamically adjusts how the targets game system 100, 200, 300, 400, 500, 1000 is controlled based on that learning mode. Also, each of the game systems 100, 200, 300, 400, 500, 1000 may include a recording mode so that a player may review how they played the game or so that players may conduct an “instant replay” moment in the case of questions on play of the game/players.

In accordance with one embodiment of the invention, the entertainment system 100, 200, 300, 400, 500, 1000 may be used to implement a game to be played by one or more players. One such game may be referred to as “Turbo Target Toss.” In this game, the two (or more) stanchions (or poles) 402 may be configured as shown in the Figures. The player(s) stand a predetermined distance (for example, ten feet) from the game system 402 facing the one or more targets 406 which may be colored differently for each player. It should be appreciated that in one embodiment, there should be at least one target 406 for each player. In this embodiment, there are four players and the four targets 406 are nets, wherein of the nets 406 have a different color netting: one green net, one blue net, one red net and one yellow net. Each of the players is assigned a colored net and have a predetermined number of colored balls (in this embodiment, 6 colored balls each), wherein the balls correspond to the color of the player's net. The cord moving device 410 is operated to cause the nets 406 to move back and forth between the game poles 402. As the nets 406 are moving back and forth, each of the players, standing 10′ away from the nets 406, attempt to throw as many balls as possible into the colored net to which they were assigned. The player that ends up with the greatest number of balls inside of their assigned net 406 is declared the winner.

In accordance with another embodiment of the invention, the entertainment system 100, 200, 300, 400, 500, 1000 may be used to implement a game referred to as “Dash & Splash.” In this embodiment, the game is configured for four players, although in other embodiments, more or less players may play. The four (or more) stanchions (or poles) 102, 202, 204, 302 may be configured as shown in the Figures and the player(s) may stand inside of the game space 126, 218, 328, 412 and/or on the periphery of the game system 100, 200, 300, 400, 500, 1000. There are four (more or less) targets securely associated with the target cord (or target connection device) 104, 230, 306, 404, wherein each of the targets are configured to change color when they get wet, wherein a different color (red, blue, yellow and green) is assigned for each player. As the game is operated, the target is moved back and forth along the periphery (in a changing or random direction and/or varying speeds if desired) or within the game space of the game system 100, 200, 300, 400, 500, 1000. This increases the difficulty of the game as the direction and speed of the target is constantly changing. Each of the players are given a squirt gun and as the target is moving, the player tries to hit the target with water. Each of the players stand and/or run around in the game play area and attempt to change the color of their own target as much as they can by squirting it with water. The player with the target that has the greatest amount of color at the end of the game will be declared the winner.

In accordance with still yet another embodiment of the invention, the entertainment system 100, 200, 300, 400, 500, 1000 may be used to implement a game referred to as “Capture the Flag-Turbo.” In this embodiment, the game is configured for four players, although in other embodiments, more or less players may play. The four (or more) stanchions (or poles) 102, 202, 204, 302, 402 may be configured as shown in the Figures and the player(s) may stand inside of the game space 126, 218, 328, 412 and/or on the periphery of the game system 100, 200, 300, 400, 500, 1000. In this embodiment, the game poles 102, 202, 204, 302, 402 are configured to a height that allows the targets to be located at a height above the heads of the players. One or more targets (e.g., flags) may be attached to the target cord (or target connection device) 104, 230, 306, 404 via Velcro® or some other easily releasable device and/or method. The gaming system is operated to cause the targets to move in an X-Y plane throughout the inside of the game space 126, 218, 328, 412 and/or on the periphery of the game system 100, 200, 300, 400, 500, 1000 above the heads of the players. The players score points by grabbing the moving target (in this embodiment a flag) from the target cord (or target connection device) 104, 230, 306, 404 and then running it across the goal line. This game may allow for two teams of 1-6 players each that compete to “capture” the overhead flag and run the captured flag past the furthest goal line without having their own belt's flag taken off of them. Each time a “captured” flag is brought past the furthest goal line, a point is awarded to the team. The team with the most points at the end of a predetermined time period of play (for example, 30 minutes) will be declared the winner.

In accordance with still yet another embodiment of the invention, the entertainment system 100, 200, 300, 400, 500, 1000 may be used to implement games that have a specific theme, such as Halloween, Thanksgiving, Christmas, etc. In this embodiment, the game platform 100, 200, 300, 400, 500, 1000 may be configured to move hanging decorations across and/or around the game space and/or perimeter of the game space. As discussed hereinafter, the targets may be themed targets which are moved via a manual, auto-learning and/or preset controller which can vary the speed, direction and/or the number of times per hour one or more of the targets are moved. Moreover, the game platform 100, 200, 300, 400, 500, 1000 may be configured to move in three dimensions, incorporating a height movement of the target. In accordance with one embodiment of the invention, the targets may be ‘ghosts’ and/or ‘witches’ that fly around the perimeter of the yard (e.g., game space) at varying heights, speeds and directions. As such, they can fly anywhere in the yard swooping high and low (via a z-axis spool/spindle), where the speed & direction can be varied or changed via manually or preset input. In accordance with still yet another embodiment, the target may be ‘Santa and his sleigh & reindeer’ which can land in the yard for a brief moment & then fly away again. Moreover, it is contemplated that the game system 100, 200, 300, 400, 500, 1000 may be used to implement a ‘moving decorations mode for celebratory events, such as Christmas, New Years, Halloween, birthdays, weddings, etc.

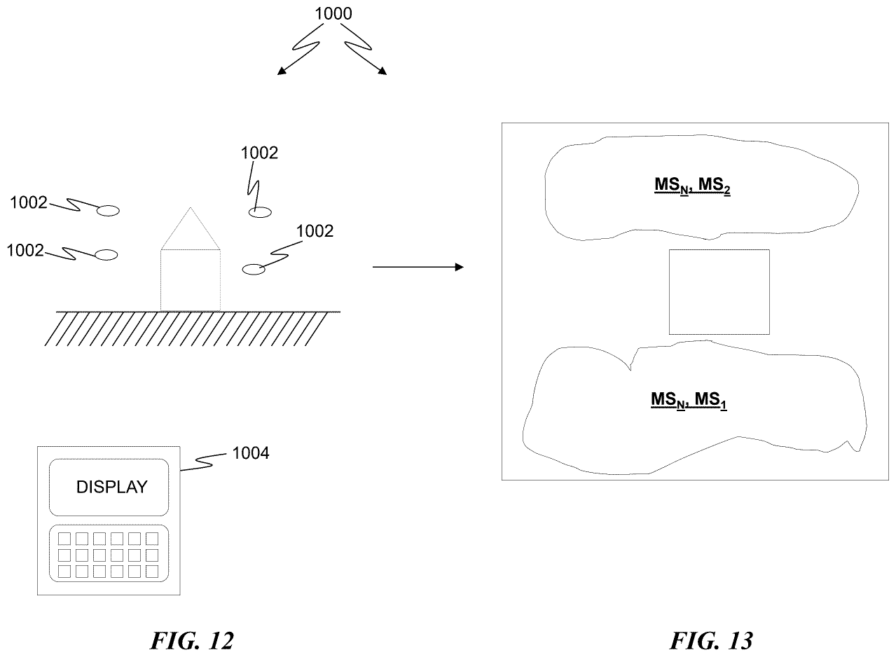

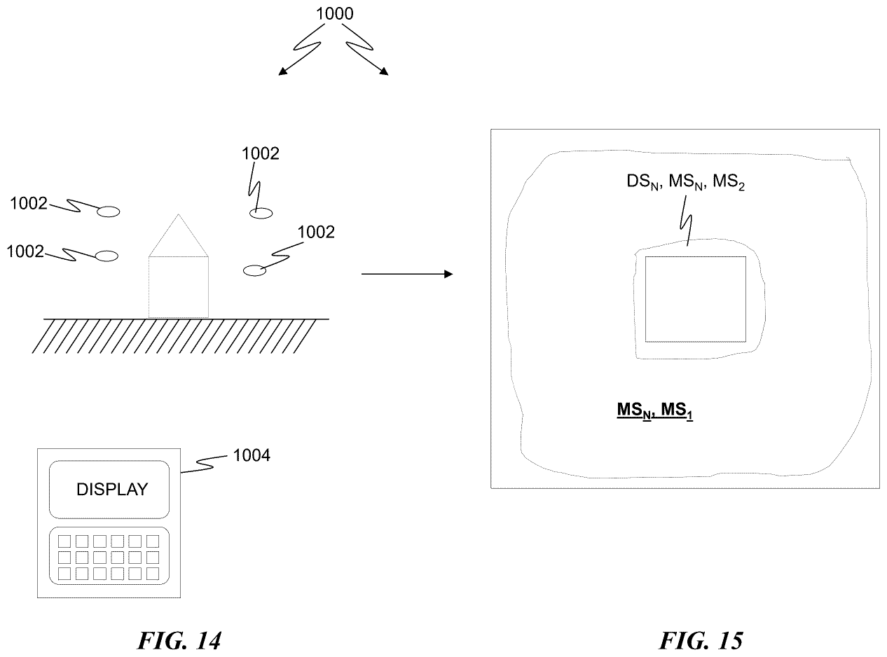

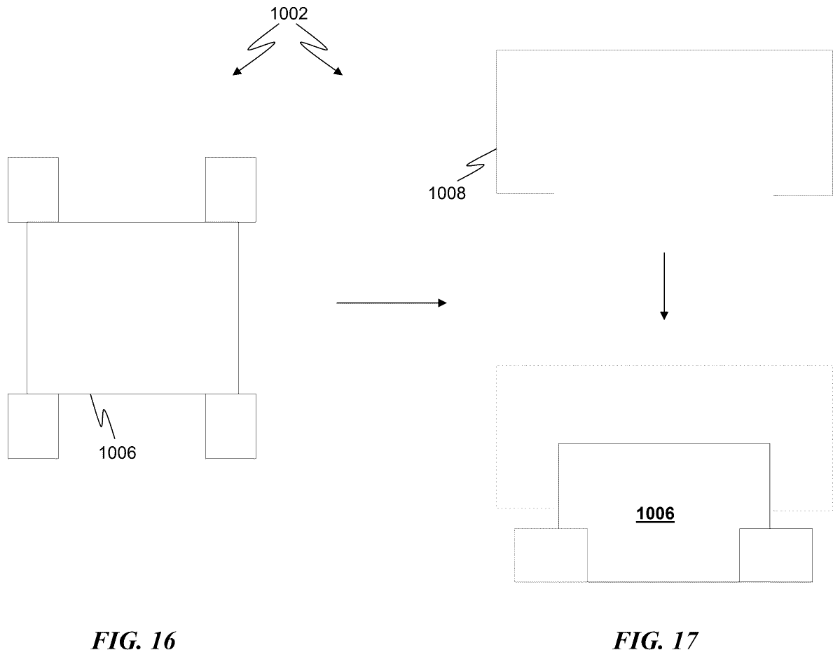

It should be appreciated that as discussed hereinabove with reference to FIG. 12, FIG. 13, FIG. 14, FIG. 15, FIG. 16 and FIG. 17, the entertainment system 100, 200, 300, 400, 500, 1000 may also be accomplished via one or more wirelessly controlled aerial and/or surface traveling vehicles or drones and/or one or more sky-cam spindle type of device arrangements. The drones may be controlled via processing device via a wireless or a hard-wired connection and the drones may be battery powered, solar powered or they may be connected to a power source via a hard-wired connection for endless power. Moreover, the drones, sky-cam spindle and/or cord moving devices, may be controlled via a processor or other control device which may be operated via a remote device or via a hard-wired device. Additionally, the drones, sky-cam spindle and/or cord moving devices may be operated and controlled via a pre-programmed gaming pattern or gaming method.

In accordance with an embodiment and as briefly discussed hereinabove, the invention may include an entertainment system 1000 which includes one or more wirelessly controlled vehicles 1002 which are controlled via a processing device 1004 that is in wireless communication with each of the vehicles 1002 and/or that is integrated with each of the vehicles 1002. It should be appreciated that each of the vehicles 1002 may include a main body 1006 which allows the vehicle 1002 to be controllably moved and operated in an aerial manner (i.e., flying) and/or in a surface manner (i.e., flying). Additionally, the vehicle 1002 may also include a façade body 1008 which is configured to securely associate with the main body 1006 to cover at least a portion of the main body 1006 to change the appearance of the vehicle 1002. For example, in one embodiment, if the invention 1000 is being used for Christmas Display, the façade body 1008, which may be removably secured to the main body 1006, may be shaped as Santa's Sleigh to allow the vehicle 1002 to have an appearance of Santa's Sleigh. Thus, as the vehicle is moving through the air, it would appear to be Santa Claus coming to leave presents. In another embodiment, if the invention 1000 is being used for a Halloween Display, the façade body 1008 may be configured as a witch flying on a broom. Thus, the façade body 1008 would cause the vehicle 1002 to have an appearance of a witch flying through the air on a broom. It should be appreciated that the façade body 1008 may be removably connected to the main body 1006 via any device and/or method suitable to the desired end purpose, such snapping/sliding into place on the main body 1006 and/or such as that used on remote controlled model vehicles. It is also contemplated that in another embodiment, one or more of the vehicles may include sensing devices, that can detect when the vehicle is “hit” by a projectile and/or by a Laser or infrared/ultraviolet beam. This would advantageously allow the vehicles 1002 to be used for targeting, thereby allowing the display to be used for targeting games, such as ‘shooting’ games as discussed hereinabove.

In an embodiment, the processing device 1004 may be configurable to define one or more sub-display-spaces DS_{N} (DS₁, DS₂, DS₃, . . . . DS_{N}) within one or more master display-spaces MS_{N} (MS₁, MS₂, MS₃, . . . . MS_{N}). For example, in one embodiment, if the invention is being used as a Halloween Display outside of a house having a front yard and a back yard, the processing device 1004 may a define a first master display-space MS₁ in the front yard the house and a second master display-space MS₂ in the back yard of the house, wherein each of the first master display-space MS₁ and the second master display-space MS₂ may be a three dimensional space which is defined by an X-plane, a Y-plane and a Z-plane. In this embodiment, the first master display-space MS₁ may be configured to include multiple vehicles 1002 which are configured as ghosts, goblins and/or witches that move around inside of the first master display-space MS₁. The goblins may be configured to move on the XY-plane within the first master display-space MS₁ while the ghosts and witches may be configured to move or ‘fly’ within the XYZ-plane within the first master display-space MS₁. Additionally, the second master display-space MS₂ may be configured to include multiple vehicles 1002 which are configured as ghosts, witches and/or warlocks that move around inside of the second master display-space MS₂. The ghosts, witches and/or warlocks may be configured to move or ‘fly’ within the XYZ-plane within the second master display-space MS₂.

In accordance with an embodiment, the processing device 1004 of the entertainment system 1000 may also be configured to divide a second master display-space MS₂ within a first master display-space MS₁. For example, in the embodiment described hereinabove, the land surrounding the house which includes the front yard and the back yard of the house may be defined as a first master display-space MS₁. The processing device may further define a second master display-space MS₂ which is equal to the XYZ plane space of the footprint of the house. Accordingly, multiple vehicles 1002 which are configured as ghosts, goblins and/or witches may move around the XYZ plane of the inside of the first master display-space MS₁. This would allow one or more vehicles 1002 to controllably move around the first master display-space MS₁, including moving around the house between the front yard and the back yard.

In still yet another embodiment, in the above example, the processing device 1004 may be configured to create a second master display-space MS₂ within the first master display-space MS₁, where the processing device 1004 may be able define the XYZ planes of both the first master display-space MS₁ and the second master display-space MS₂. Accordingly, the processing device 1004 may define a first master display-space MS₁ which includes a house and the front yard, back yard and side yards of the house. The processing device 1004 may then define a second master display-space MS₂ within the first master display-space MS₁ which defines the XY plane (i.e., a two dimensional flat surface defined by two perpendicular oriented directions) as the perimeter of the house and the Z plane (i.e., a plane oriented in a perpendicularly vertical direction relative to the XY plane) as the vertical height of the house. The processing device 1004 may then define all or some of the second master display-space MS₂ as an exclusion zone, thereby not allowing some or any of the vehicles 1002 from entering or traversing within all or some of the second master display-space MS₂. In this embodiment, one or more of the vehicles 1002 can then fly/move completely around and over the house unimpeded without fear of the vehicles 1002 hitting the house.

It should be appreciated that the master display-spaces MS_{N} may be created via any device and/or method suitable to the desired end purpose. For example, in one embodiment, the master display-space MS_{N} may be created by a user locating the processing device 1004 at a location on the perimeter of the desired master display-spaces MS_{N}. The user may then instruct the processing device 1004, which may be communicated with a Global Positioning System (GPS) device, to receive the coordinates of the location of the processing device 1004 and to set that location as a starting point location along the perimeter of the master display-space MS_{N}. The user, holding the processing device 1004, then walks the length of the master display-space MS_{N} back to the starting point location while the processing device 1004 records the GPS coordinates along the length of the path walked by the user. The user may also input a desired height of the display-space. The processing device 1004 may then define the master display-space MS_{N} by the GPS coordinates along the path walked by the user. A second master display-space MS₂ may be created in the same way. For example, a second master display-space MS₂ may be created within the master display-space MS_{N} as described hereinabove. In another embodiment, a user can directly input the GPS coordinates (including height of the desired display-space) into the processing device 1004 which defines the master display-space MS_{N} via an input device, such as a keyboard.

It should be appreciated that as used herein, entertainment system, gaming platform, gaming system, etc. may be used interchangeably. Moreover, it is contemplated that in various other embodiments, the entertainment system 100, 200, 300, 400, 500, 1000 may be used as an animated decoration system as well. For example, during Halloween, the entertainment system 100, 200, 300, 400, 500, 1000 may be used to cause objects, dolls and/or figurines (witches, ghosts, goblins, etc.) to ‘fly’ across a defined space such as a yard of a house or other building. Or the entertainment system 100, 200, 300, 400, 500, 1000 may include remote controlled or programmable drones (preprogrammed) to be used to cause objects, dolls and/or figurines (witches, ghosts, goblins, etc.) to ‘fly’ across a defined space such as a yard of a house or other building. In another example, during Christmas the entertainment system 100, 200, 300, 400, 500, 1000 may be used to cause objects, dolls and/or figurines (elves, reindeer, Santa Claus, etc.) to ‘fly’ across a defined space such as a yard of a house or other building. Or the entertainment system 100, 200, 300, 400, 500, 1000 may include remote controlled or programmable drones to be used to cause objects, dolls and/or figurines (elves, reindeer, Santa Claus, etc.) to ‘fly’ across a defined space such as a yard of a house or other building.

In accordance with an exemplary embodiment, the method of the invention may be implemented through a controller operating in response to a computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing. Moreover, the method of the invention may be embodied in the form of a computer or controller implemented processes and apparatuses for practicing those processes. As such, the methods and embodiments described hereinabove and in the several figures may also be embodied in the form of computer program code containing instructions embodied in tangible media, such as floppy diskettes, CD-ROMs, hard drives, flash drives, DVDs, etc., or any other computer-readable storage medium, wherein, when the computer program code is loaded into and executed by a computer, the computer becomes an apparatus for practicing the invention.

While the invention has been described with reference to an exemplary embodiment, it should be understood by those skilled in the art that various changes may be made and equivalents may be substituted for elements thereof without departing from the scope of the invention. Moreover, the embodiments or parts of the embodiments may be combined in whole or in part without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. An entertainment system comprising:
at least one support pole;
at least one attachment cord;
a motor, wherein the motor is associated with the support pole and the attachment cord; and
a target, wherein the target is connected to the attachment cord, and
wherein the motor is operable to cause the target to move in at least one of a vertical direction, a horizontal direction and a circular direction relative to the at least one support pole via the attachment cord.

2. The entertainment system of claim 1, wherein the at least one support pole includes a plurality of support poles which define a perimeter of an entertainment space located between the plurality of support poles.

3. The entertainment system of claim 2, wherein the entertainment space is further defined in at least one of,
a two-dimensional XY plane, and
a three-dimensional XYZ plane.

4. The entertainment system of claim 2, wherein the plurality of support poles includes a control pole, a second pole, a third pole and a fourth pole, wherein the attachment cord is movably associated with the control pole via the motor, and wherein the attachment cord is further movably associated with the second pole via a second pole pully, the third pole via a third pole pully and the fourth pole via a fourth pole pully.

5. The entertainment system of claim 4, wherein
the motor is operable to cause the attachment cord to move relative to the control pole, through the second pole pully, the third pole pulley and the fourth pole pulley to cause the target to move about the perimeter of the entertainment space.

6. The entertainment system of claim 1, further comprising a processing device, wherein the processing device is configured to control the movement of the target by controlling the operation of the motor.

7. The entertainment system of claim 6, wherein the processing device is at least one of,
a remote device, and
a controller integrated with at least one of the target and the motor.

8. The entertainment system of claim 7, wherein target is associated with the attachment cord via a target connection device, and wherein at least one of the target and the target connection device includes a sensing device for sensing when an electromagnetic beam, a fluid stream or a kinetic projectile contacts the target.

9. The entertainment system of claim 8, wherein the sensing device is communicated with the processing device to alert the processing device that the target was contacted by at least one of an electromagnetic beam, a fluid stream and a kinetic projectile.

10. The entertainment system of claim 2, wherein the attachment cord is movable in a first direction and a second direction and wherein the motor is operable to move the attachment cord around the perimeter of the entertainment space in at least one of the first direction and the second direction at a cord speed, wherein the cord speed is controllably variable in a speed range between 0 miles per hour and about 35 miles per hour±10%.

11. The entertainment system of claim 3, wherein the at least one attachment cord includes a plurality of attachment cords, wherein the plurality of attachment cords are arranged to cause the target to move in at least one of,
the two-dimensional XY plane within the entertainment space, and
the three-dimensional XYZ plane within the entertainment space.

12. The entertainment system of claim 1, wherein the at least one support pole includes the control pole and the first support pole, wherein the attachment cord is associated with the target and wherein the attachment cord and the target are movably associated with the control pole and the first support pole via the motor such that the attachment cord and the target move between the control pole and the first support pole.

13. The entertainment system of claim 12, wherein the attachment cord and the target are movable in a first direction and a second direction and wherein the motor is operable to move the attachment cord in at least one of the first direction and the second direction a cord speed, wherein the cord speed is controllably variable in a speed range between 0 miles per hour and about 35 miles per hour±10%.

14. An entertainment system comprising:
at least one Remotely Controlled Vehicle (RCV) containing a vehicle processing device; and
a Remote Control Device (RCD) containing a control processing device, wherein the control processing device is communicated with the vehicle processing device to control the operation of the RCV, wherein the RCD and the RCV are configured to receive GPS coordinates, and wherein the RCD is configured to control and limit the location of the RCV to an entertainment space located within an entertainment space perimeter defined by a first set of GPS coordinates.

15. The entertainment system of claim 14, wherein the RCD is configured to sense and store the first set of GPS coordinates by being moved along the entertainment space perimeter to define the entertainment space.

16. The entertainment system of claim 15, wherein the RCD is configured to communicate the first set of GPS coordinates to the RCV, and wherein the RCV is configure is configured to receive the first set of GPS coordinates from the RCD.

17. The entertainment system of claim 16, wherein the RCV is configured to sense and store a second set of GPS coordinates responsive to its location.

18. The entertainment system of claim 16, wherein the RCD compares the first set of GPS coordinates with the second set of GPS coordinates to ensure that the RCV is located within the entertainment space.

19. The entertainment system of claim 18, wherein the RCD communicates with the RCV to cause the RCV to operate within the entertainment space.

20. A method for implementing an entertainment system, wherein the entertainment system includes at least one Remotely Controlled Vehicle (RCV) containing a vehicle processing device and a Remote Control Device (RCD) containing a control processing device, wherein the control processing device is communicated with the vehicle processing device to control the operation of the RCV, wherein the RCD and the RCV are configured to receive GPS coordinates, and wherein the RCD is configured to control and limit the location of the RCV to an entertainment space located within an entertainment space perimeter defined by a first set of GPS coordinates, the method comprising:
moving the RCD along the entertainment space perimeter to cause the RCD to receive a first set of GPS coordinates responsive to multiple locations along the entertainment space perimeter to define the entertainment space;
storing the first set of GPS coordinates;
communicating the first set of GPS coordinates to the RCV;
locating the RCV within the entertainment space;
powering up the RCV to cause the RCV to sense a second set of GPS coordinates responsive to a location of the RCV;
comparing the first set of GPS coordinates with the second set of GPS coordinates to determine if the second set of GPS coordinates are within the first set of GPS coordinates; and
if the second set of GPS coordinates are within the first set of GPS coordinates, then operating the RCV to cause the RCV to controllably traverse the entertainment space, and
if the second set of GPS coordinates are not within the first set of GPS coordinates, then preventing the RCV from being operated.
